(19) United States
(12) Patent Application Publication
(10) Pub. No.: US 2015/0228201 A1
(43) Pub. Date: Aug. 13, 2015

(54) Photo Strings

(71) Applicant: Crayola, LLC, Easton, PA (US)

(72) Inventor: Brian Edward Nemeckay, Belvidere, NJ (US)

(21) Appl. No.: 14/621,073

(22) Filed: Feb. 12, 2015

Related U.S. Application Data
(60) Provisional application No. 61/939,564, filed on Feb. 13, 2014.

(51) Int. Cl. G09B 11/00; G09B 5/00

(52) U.S. Cl. CPC G09B 11/00; G09B 5/00

(57) ABSTRACT

A method of generating user-created animated artwork from a photo string is provided. Embodiments include selection of an original image, such as a photograph, for generation of a drawn image. The original image may be cropped to a particular dimension and an animation material and/or “string” texture may be selected for generating an unwound drawing string. As an image is converted into artwork by the user, a segment of pixels of the selected image is sequentially separated from the original image and used to create the drawing string. In embodiments, the detached portion of the original image is blurred to create a solid band of color correspondings to the original image. The drawn image may be configured for animation with respect to the original image.

### CROSS REFERENCE TO RELATED APPLICATIONS

This Nonprovisional Patent Application claims priority to Provisional Patent Application No. 61/939,564, filed Feb. 13, 2014, entitled “PHOTO STRINGS,” which is incorporated by reference in its entirety.

### SUMMARY

Embodiments of the invention are defined by the claims below, not this summary. A high-level overview of various aspects of the invention is provided here for that reason, to provide an overview of the disclosure, and to introduce a selection of concepts that are further described below in the detailed description section. This summary is not intended to identify key features or essential features of the claimed subject matter, nor is it intended to be used as an aid in isolation to determine the scope of the claimed subject matter. The scope of the invention is defined by the claims.

In brief and at a high level, this disclosure describes, among other things, a method of generating user-created animated artwork, and a user interface configured for providing the same. In embodiments, a previously generated or newly created user image is selected by a user to provide an original image for modification. The selected image (i.e., the “original image”) may be cropped to particular dimensions, a background may be chosen and/or applied to the image, and an animation material and/or “string” texture may also be chosen. In further embodiments, a user may choose from one of multiple string options, including different materials, colors, and/or textures that provide distinctive visual characteristics to the drawing string. To generate artwork from the original image, a segment of pixels may be sequentially extracted from the original image to provide a drawing and/or coloring medium. For example, a segment of pixels at the right-most portion of the original image may be detached and used to create the drawing string. The string may then be used to generate the user-created animated artwork, the string sequentially and continuously extracting portions of the original image as the artwork is created. As such, in some embodiments, the original image may remain intact while portions of the image are sequentially transformed into pixels of a drawing string for drawing by a user. In response to user interaction, the colored pixels of the original image may become the colored pixels of the drawing string used to generate a drawn object.

In an embodiment, the segment of pixels sequentially detached from the original image includes a particular number and/or width of pixels for removal and conversion into a drawing string. In one embodiment, a portion and/or number of pixels of the original image may be extracted, detached, and/or unraveled from the original image during creation of a drawn image with drawing string, such as a portion including 10-15 pixels. Although 10-15 pixels is one embodiment of a number of pixels for providing a segmented unwinding of the original image, any number of pixels may be extracted, detached, and/or unraveled for use in drawing, depending on the desired width of the drawing string, the desired length of the drawing string and/or the desired characteristics of the drawing string. While the drawing string is generated, the extracted/detached/unraveled pixels may remain coupled to the original image based on adjoining pixels remaining in contact with the original image. For example, a ten-pixel segment of an original image may remain coupled to the original image based on adjacent pixels on a first axis of an original image, while the same ten-pixel segment of the original image is detached from the original image along a second axis. As such, a segment of pixels may be gradually “unraveled” while still remaining coupled to the original image, and may remain coupled to a portion of the original image while the particular portion of pixels is being sequentially detached from a different portion.

In some embodiments, as the original image is converted into the drawing string, one or more colors corresponding to the sequentially separated portion of the original image may be combined, altered, blended, blurred, or otherwise augmented to provide a drawing string having coloration corresponding to the original image. For example, as the original image is converted into the drawing string, the detached and/or sequentially separated portion of the original image may be blurred to create a solid band of color that corresponds to the portion of the original image from which the drawing string was derived. In some embodiments, a string of color (e.g., a sequence of colors) extracted from the original image is used as a drawing tool for generating the user-created artwork. As the string of color is manipulated to generate the artwork, the original image may continue to be unraveled until either the drawing is complete and/or the entire selected image has been used (e.g., all pixels of the selected image have been separated into a string and used for drawing). In some embodiments, a border may be generated around the user-generated artwork during and/or after completion of the artwork, using the drawing string. The border may be similar to, or the same as, the string of color manipulated for drawing, and may be configured to have different styles or designs. As such, additional artwork may be generated upon completion of the drawn image, using a drawing technique and/or tool corresponding to the drawings string derived from the original image.

In certain embodiments, the progression and/or sequence of drawing actions indicated by the user are recorded during the drawing process. In one embodiment, the drawing process is recorded and is configured to play back as sequential images, or rather, configured to play back as an animation. As such, each extraction of pixels from the original image, and each segment of corresponding drawn image content, may be captured for presentation to the user generating the artwork and/or to a different user (e.g., a recipient of the artwork). In some embodiments, a recorded sequence of drawing steps during extraction, string conversion, and drawing may be displayed to a user. For example, a user may control and/or “scrub” a timeline tool backward and forward, corresponding to unwinding and/or rewinding of the drawn image, to animate the process of image construction. As such, a user may “rewind” their drawing at any time by re-attaching the drawing string to the original/selected image. In further aspects, the user may manipulate the timeline tool to recommence drawing at any point along their creation.

In embodiments of the invention, a resulting animation may be generated, which demonstrates the transformation from the original image to a drawn image. Such animation may then be configured to loop back to the starting format of the original image by rewinding of the animation. Accordingly, embodiments of the invention are configured to generate user-created animated artwork using an original image, such as a photo, with portions of the original image being separated into a drawing string, and the drawing string being used to create the drawn artwork. In further aspects, the drawn image may be displayed by a sender or a recipient of the drawn artwork/image, and the process of generating the drawn artwork/image from the original image may be animated based on presenting the unwinding of the original image and/or rewinding of the drawn image. The resulting animation may be displayed by either the sender or the receiver of the artwork. For example, a sender may select an original image, extract a drawing string and generate a drawn image, and provide an indication of animation to generate a presentation of the user's sequential generation of the drawn image. In another embodiment, having been created by the sender/user, a recipient/user may receive an indication to view an animation sequence, such as an emailed message or a link to content provided to the recipient. The recipient may then view the generated animation corresponding to the sender/user's generation of the drawn artwork/image. For example, the recipient may receive content associated with displaying the drawn image, from which the animation may “rewind” to provide a presentation of the original image to the recipient. Similarly, the recipient may receive content associated with displaying the original image, from which the animation may “unwind” to provide a presentation of the drawn image to the recipient.

Accordingly, in one embodiment, a method, executed by a processor, for generating animated artwork from a photo string, is provided. The method includes selecting an image to provide an original image, sequentially extracting a portion of the original image to provide an original image, selecting a drawing string, and generating a drawn image comprising one or more portions of the original image. In one embodiment, the original image is a photograph. In further embodiments, the portion of the original image is a segment of pixels of the original image, which may include a segment of a particular number of pixels, such as a segment including 10 to 15 pixels of the original image. In further embodiments, the drawn image is animated with respect to the original image. A string material corresponding to the drawing string may be selected by a user. The string material may comprise various styles, patterns, and color sequences. Further, in some embodiments, a timeline tool may be configured to translate the drawn image between the original image and the drawn image.

In another embodiment, a method, executed by a processor, for interacting with a user-created animated artwork, is provided. The method includes receiving an indication of the user-created animated artwork, and initiating at least one animation of the user-created animated artwork, the at least one animation comprising an unwinding of an original image associated with the received indication, and/or a rewinding of a drawn image associated with the received indication. In embodiments, the original image is a photograph. In some embodiments, the method further comprises receiving an indication of completion of a drawn image, wherein the drawn image is created using a drawing string. In embodiments, the method further includes translating a timeline tool to unwind or rewind at least a portion of the drawn image to or from the original image. The drawn image may also be configured for animation with respect to the original image.

In another embodiment, a method, executed by a processor, for interacting with a user-generated animated artwork, is provided. The method includes receiving an indication of a user-generated animated artwork, said user-generated artwork comprising a drawn image created using a drawing string comprising a strand of pixels sequentially extracted from at least a portion of an original image, and initiating at least one animation of the user-generated animated artwork, the at least one animation comprising an unwinding of at least a portion of the original image associated with the received indication into a least a portion of the drawn image, or a rewinding of at least a portion of the drawn image associated with the received indication into at least a portion of the original image. The method may further include receiving an indication of completeness of the drawn image, and receiving an indication of rewinding from a timeline tool and sequentially rewinding a drawing string from the drawn image to the original image, wherein the drawing string comprises sequentially extracted color segments from at least a portion of the original image. The method may also include receiving an indication of unwinding from a timeline tool and sequentially unwinding a drawing string from the original image to the drawn image according to a previously-drawn image using the drawing string sequentially extracted from at least a portion of the original image.

In another embodiment, one or more computer storage media storing computer-usable instructions that, when used by one or more computing devices, cause the one or more computing devices to perform the method comprising receiving an indication of an image selected to provide an original image, receiving a selection of at least one string option, sequentially extracting at least a portion of the original image to provide a drawing string, and generating a drawn image comprising one or more portions of the original image, wherein the drawn image is generated from a segment of pixels on the original image, wherein the segment of pixels is sequentially separated from at least a portion of the original image and used to create the drawing string.

The at least one string option may comprise a thread texture, an embroidery texture, a sweater fabric texture, knit stitch texture, melted crayon texture, and/or glitter glue texture, or other textural, color, or visual string variations selected by the user. The method may further comprise selecting a string of color from the original image and manipulating the string of color to generate the drawn image, wherein as the string of color is manipulated, the original image unravels until either the drawn image is complete or the entire original image has been unraveled. In embodiments, as the original image is converted into the drawing string, two or more pixels of the separated portion of the original image are blurred to create a solid band of color that corresponds to the portion of the original image from which it was derived.

In another embodiment, a graphical user interface (GUI) stored on one or more computer storage media and executable by a computing device is provided. The GUI includes an original image display, a photo string display for creation of a drawn image, and a timeline tool configured to advance and/or retract the drawn image. In embodiments, the GUI includes an original image that is a photograph. In further embodiments, the timeline tool includes a slider configured to indicate advancement or retracting of the drawn image.

### DESCRIPTION OF THE DRAWINGS

Illustrative embodiments of the invention are described in detail below with reference to the attached drawing figures, wherein:

FIG. 1A depicts an exemplary selected and/or original image, in accordance with an embodiment of the invention;

FIG. 1B depicts a drawn image created using the exemplary selected image of FIG. 1A, in accordance with an embodiment of the invention;

FIG. 2A is an exemplary portion of an unwound drawing using the selected image of FIG. 1A, in accordance with an embodiment of the invention;

FIG. 2B is an exemplary portion of an unwound drawing using the selected image of FIG. 1A, in accordance with an embodiment of the invention;

FIG. 2C is an exemplary portion of an unwound drawing using the selected image of FIG. 1A, in accordance with an embodiment of the invention;

FIG. 2D is an exemplary portion of an unwound drawing using the selected image of FIG. 1A, in accordance with an embodiment of the invention;

FIG. 3 is a screen shot of an exemplary user interface for generating a user-created drawing from a selected image, in accordance with an embodiment of the invention;

FIG. 4 is a screen shot of an exemplary user interface for generating a user-created drawing from a selected image, in accordance with an embodiment of the invention;

FIG. 5 is a screen shot of an exemplary user interface for generating a user-created drawing from a selected image, in accordance with an embodiment of the invention;

FIG. 6 is a screen shot of an exemplary user interface for generating a user-created drawing from a selected image, in accordance with an embodiment of the invention;

FIG. 7 is a screen shot of an exemplary user interface for generating a user-created drawing from a selected image, in accordance with an embodiment of the invention;

FIG. 8 is a screen shot of an exemplary user interface for generating a user-created drawing from a selected image, in accordance with an embodiment of the invention;

FIG. 9 is a screen shot of an exemplary user interface for generating a user-created drawing from a selected image, in accordance with an embodiment of the invention;

FIG. 10 is a flowchart of a first method of generating a user-created artwork from an original image, in accordance with an embodiment of the invention;

FIG. 11 is a flowchart of a second method of generating a user-created artwork from an original image, in accordance with an embodiment of the invention;

FIG. 12 is a flowchart of a third method of generating a user-created artwork from an original image, in accordance with an embodiment of the invention; and

FIG. 13 depicts an exemplary computing device configured to generate a user-created animated artwork from a selected and/or original image, in accordance with an aspect of the invention.

### DETAILED DESCRIPTION

The subject matter of select embodiments of the invention is described with specificity herein to meet statutory requirements. However, the description itself is not intended to necessarily limit the scope of claims. Rather, the claimed subject matter might be embodied in other ways to include different components, steps, or combinations thereof, similar to the ones described in this document, and in conjunction with other present or future technologies. Terms should not be interpreted as implying any particular order among or between various steps herein disclosed unless and except when the order of individual steps is explicitly described.

Embodiments of the invention provide a method for generation of user-created, animated artwork. In embodiments, a previously-generated or newly-created user image is selected to provide an original image. The original image may then be cropped to particular dimensions and an animation material, and/or “string” texture, may be chosen. A user may choose from one of multiple string options, such as a thread texture, an embroidery texture, a sweater fabric texture, a knit stitch texture, a melted crayon texture, a glitter glue texture, and other materials and/or textures for generating the unwound photo string. As the original image is converted into artwork by the user, a segment of pixels at the right-most portion of the original image is detached from the original image and used to create a string for drawing. In one embodiment, the segment of pixels includes a portion of 10-15 pixels of the original image. In some embodiments, as the original image is converted into the drawing string, the detached portion of the original image is blurred to create a solid band of color that corresponds to the portion of the original image from which it was derived.

In some embodiments, a string of color (i.e., a sequence of colors) extracted from the original image is then used as a drawing tool. As the string of color is manipulated for drawing, the original image continues to be unraveled until either the drawing is complete or the entire original image has been used (e.g., all pixels of the original image have been separated into a string and used for drawing). In embodiments, the drawing process is recorded and is configured for playback as sequential images, thereby creating an animation. In embodiments, the animation is a looped animation, beginning with the original image, cycling through to the creation of the drawn image, and back to the original image.

In further embodiments, a user may control and/or “scrub” a timeline tool backward and forward, corresponding to the generation of the drawn image. As such, a user may “rewind” their drawing at any time by re-attaching the string to the original image, and using the timeline tool to recommence drawing at any point along their creation. In embodiments of the invention, a resulting animation demonstrates the transformation from the original image to the drawn image, which then loops back to the original image by re-winding to depict the original image. In further embodiments, the animation depicts a transformation of the original image to the drawn image, and loops back directly to the display of the complete, original image.

Accordingly, embodiments of the invention are used to create drawn artwork using a photo and/or image, and demonstrate the process of creating such artwork through animation. In embodiments, a user-created image, such as a photograph, may be used to create animated artwork (e.g., a drawing). In some embodiments an original image, taken by a camera or generated by a user by other means, is cropped to a particular size, such as a square, and a string material is chosen from one of multiple string material options, such as embroidery texture, a sweater fabric texture, a knit stitch texture, a melted crayon texture, a glitter glue texture, and other materials and/or textures.

In one embodiment, a portion of pixels from a particular segment/side of the original image may be extracted, such as a portion of segments from a side of an original image that corresponds to a drawing area. For example, a segment of pixels may be extracted from a portion of an original image that is adjacent to a drawing area, such as a right-most side of an original image that is adjacent to the left-most side of a drawing area. In another example, a drawing string may be sequentially extracted from a left-most side of an original image, while the user creates a drawing on a drawing area adjacent the original image (e.g., adjacent the right most side of the drawing area). In further aspects, the original image for extraction of a drawing string may be adjacent to a drawing area and/or correspond to a particular drawing area for depositing the drawing string from the original image, and generating the drawn artwork/image by the user. In some embodiments, the right most 10-15 pixels of the selected image are extracted in a line to form a string. As the image is converted into a string, the detached portion of the image may be blurred to create a solid band of color that provides a pixel representation of the removed portion of the original image. For example, the detached portion may be blurred to represents the average of that section/portion of the original image. As a result, the drawing string (i.e., sequence of colors included on the string as it is drawn) may then be used as a drawing tool. As the string is used to draw, the original image continues unraveling in response to user interaction. In one aspect, the drawing string may be used to generate a drawn image until either the drawing is complete or the entire original image has been consumed (from the extraction along a portion of the original image including a number of pixels, to form the string).

During drawing, the string may be configured to float, remain suspended, and/or otherwise hang in the image space, such that the drawing string remains in a position where it can be easily engaged, activated, and/or moved during drawing, rather than retracting and/or disappearing from the image space, according to some embodiments. Before, during, and/or after the image is completed, the string may further form a border around the drawn image. In selected embodiments, additional options may be available to provide different backgrounds for the drawing, the backgrounds being chosen from one of a plurality of images, textures, colors, and/or visual elements provided for the user.

The selected/original image to be drawn with may be taken by the user in real time using a camera, and/or may be selected from stored images on a user device. Additionally, stock images may be provided for the user to use in creating the artwork. In this regard, original images generated by the user and standard images provided by the application may be used to generate a photo string, and a corresponding drawn image.

During drawing, the process of creation may be recorded and used for playback during demonstration of the drawing process. Further, the recorded drawing may be used to play back a recording using sequential images, thereby creating an animation. In some embodiments, the user may control a timeline tool, scrubbing it backward and forward to return to an earlier or later drawing portion of the selected image and/or to undo portions of a drawn image. As such, embodiments of a timeline tool may be used to toggle through different phases of creation according to a timeline of image generation, which corresponds to winding and/or unwinding of the user-generated image.

In some embodiments, unwinding may be used to refer to the process of removing a string from the selected/original image and creating the user's artwork, while rewinding may be used to refer to the process of returning and/or re-applying the unwound string to the original, selected image from which it was retrieved, or rather, sequentially removing it from the drawn image. In some aspects, the user's artwork (i.e., the drawn image) may be rewound into the original image based on manipulation of a timeline tool. In further embodiments, the resulting animation demonstrates the transformation from an original image to a drawn image, and may loop back to the original image. As such, this animation may be shared between users, such as by emailing the animation to another user as an animated GIF. In this regard, the artwork creator/sender may generate the artwork on a first user device, and send the artwork to a second user device, where a viewer/receiver may view the artwork or animation. The sender may also send the artwork to a cloud-based computing device, where it can be stored for retrieval by the viewer/receiver, selectively, to play on the receiver/viewer's user device.

Embodiments of the invention also include a variety of user configured settings, including selected sound effects which may be used during drawing, animation and/or playback, tutorials explaining the use and function of the application that can be selectively activated by the user, and/or options to purchase additional functionality packages. The additional functionality packages may include additional backgrounds, string options, string colors, or the ability to save drawings and/or related animations for later use or sending. Additionally, embodiments may include privacy options for allowing parents or other monitoring parties to adjust or limit the features of the application, and/or the ability to send drawings or animations to other users.

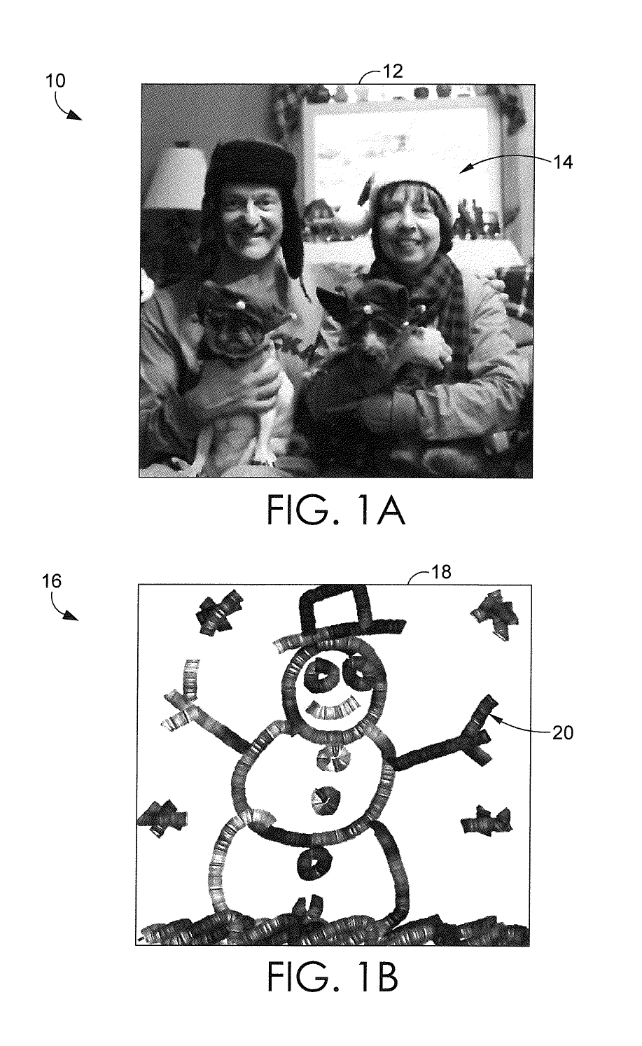

With reference now to the figures, a photo string drawing method and user interface is described in accordance with embodiments of the invention. Various embodiments are described with respect to the figures, in which like elements are depicted with like numbers. Referring initially to FIG. 1A, an exemplary user-selected and/or original image 10 is depicted according to an embodiment of the invention. The original image 10 includes image content 12 having multiple pixels 14. In one embodiment, original image 10 is a photo selected by a user. In further embodiments of the invention, original image 10 is a drawing or other image for manipulation according to embodiments of the invention, or a stock image selected by the user. In some embodiments, a recipient of an animated message may receive original image 10 as part of an email message.

As shown in FIG. 1B, a completed drawing 16 may be delivered to a recipient, based on manipulation of original image 10 of FIG. 1A. Completed drawing 16 includes image content 18 having one or more elements that define a line drawing 20. In embodiments, the line drawing 20 is created using a segment of multiple pixels 14 extracted from photo content in FIG. 1A.

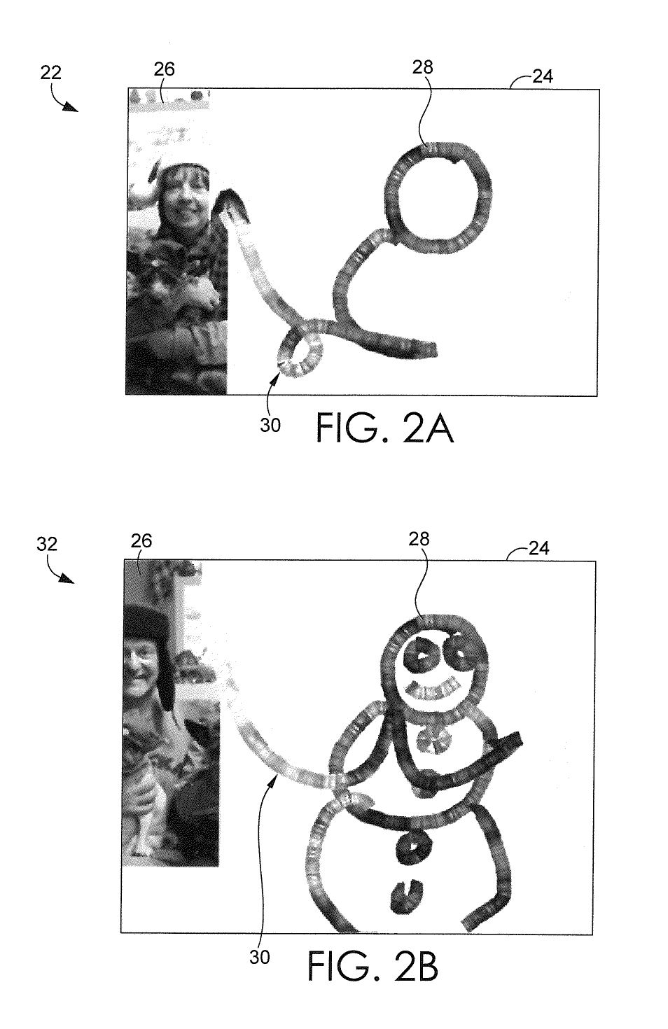

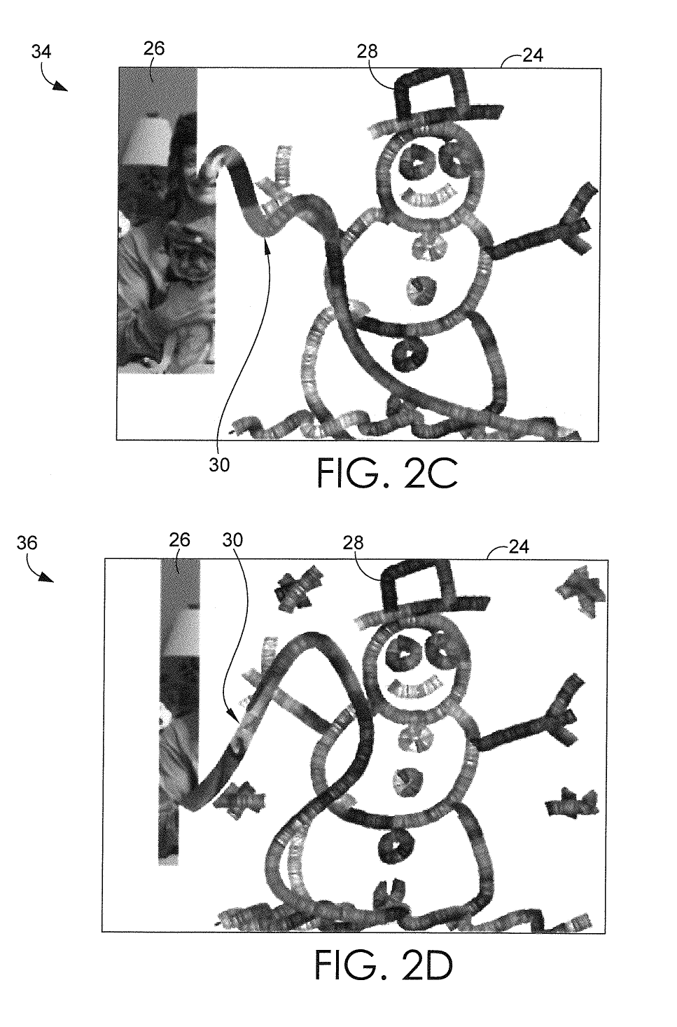

With reference next to FIG. 2A, exemplary received animation 22 presents image content 24 having an original image 26 that is unwound to produce a drawn image 28 using string 30. As the animation continues to “unwind” from the original image 26, the received animation 32 in FIG. 2B depicts how the image content 24 progressively increases to include additional elements of the drawn image 28, created from additional string 30. In embodiments, the string 30 is gradually animated over time to produce the drawn image 28, extracting pixels from a portion of the original image 26, such as pixels derived from the right edge of the original image 26 in the example of FIG. 2B. As such, elements of the drawn image 28 may be stopped and started throughout the animation, and in some embodiments, the animation may include individually drawn segments of the drawing that are not connected (e.g., separate buttons on the drawn image 28). As such, although the content of the drawing string is sequentially derived from the original image 26, the separate portions of the drawn image 28 may stop and start throughout drawing, while continuing to present colors according to the extracted sequence of pixels.

Upon further viewing of the animated artwork, as shown in the received animation 34 of FIG. 2C, the image content 24 is further advanced to include additional elements of the drawn image 28, based on further unwinding of the original image 26 with string 30. Finally, at FIG. 2D, the exemplary received animation 36 approaches completion of the message while a majority of the original image 26 is consumed to provide all of the string 30 used to create drawn image 28.

In some embodiments, an animation received by a recipient/user includes the original image 26 viewed in association with a portion of an email message. In embodiments, as shown in FIG. 1A, the complete, original image 26 may be visible to a recipient/user, upon which the image may automatically and/or in response to a prompt by the recipient begin to demonstrate art-creation animation. As shown in the example of FIG. 2A, the original image 26 may be shifted to a left-most portion of a display, while the drawn image is gradually generated to the right of the original image. As will be understood, in embodiments of the invention described herein with reference to a left and a right side and/or portion of an image or display, it should be understood that an alternate side of an image may be used in some embodiments of the invention. For example, an original image may be positioned at a right side of a display, for unwinding of string from the left-most portion of the original image, and drawing of the image on the left side of the display.

As such, following the initial unwinding animation of FIG. 2A, as shown in FIGS. 2B, 2C, and 2D, the drawn image 28 continues to “unwind” from the original image 26 using a sequentially extracted drawing string 30. In some embodiments, as discussed above, string 30 may have a particular texture and/or enhancement for appearance during drawing, such as the appearance of embroidery thread. Accordingly, while FIG. 2D depicts an almost-consumed version of the drawn image 28, upon completing the animation, the completed drawn image 20 of FIG. 1B may be presented to a recipient.

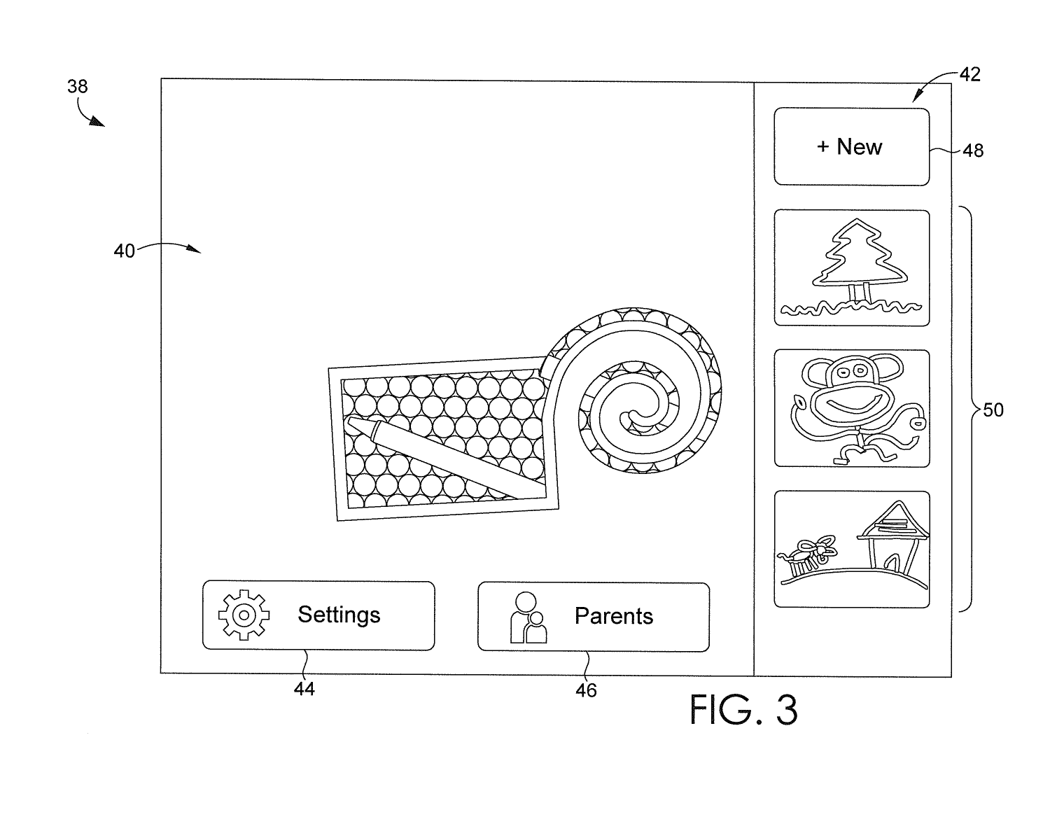

Turning now to FIGS. 3-9, a series of screen shots depicting an exemplary user interface for generating a user-created drawing from a selected image is provided, in accordance with an embodiment of the invention. In FIG. 3, user interface 38 includes a display 40 and a menu 42. The display 40 may include one or more selection indicators, such as selection indicators 44 and 46. In some embodiments, a menu 42 includes one or more options for selection by a user, such as a new drawing selection indicator 48, and a series of saved art selection indicators 50.

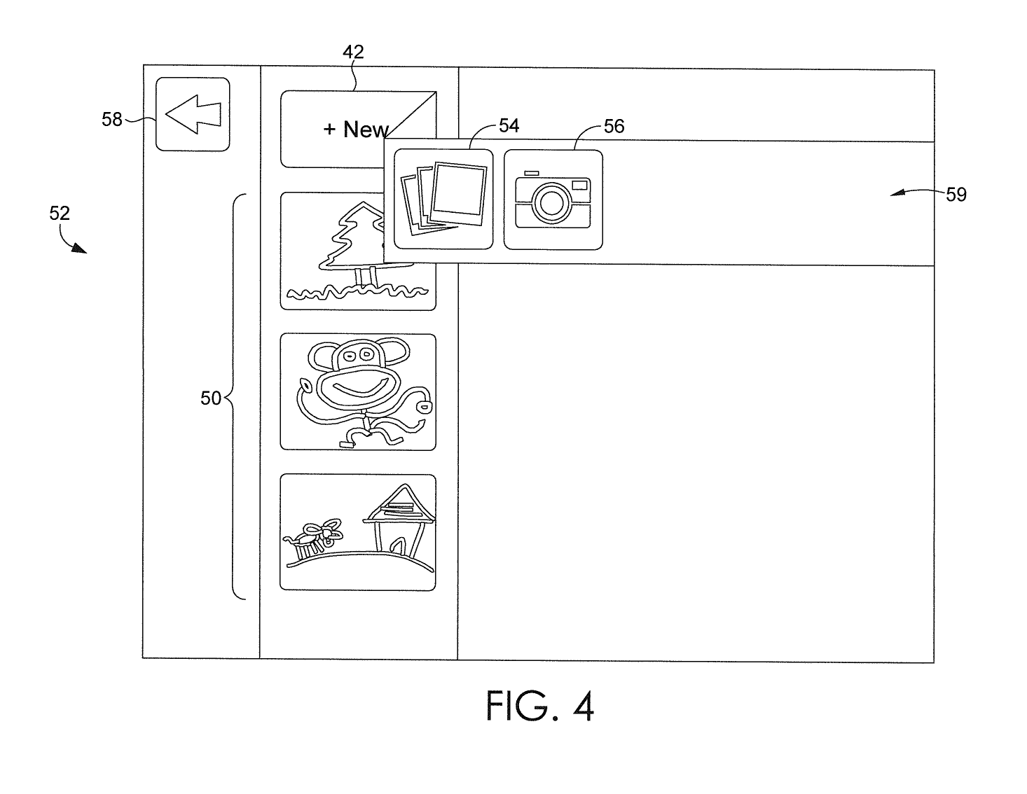

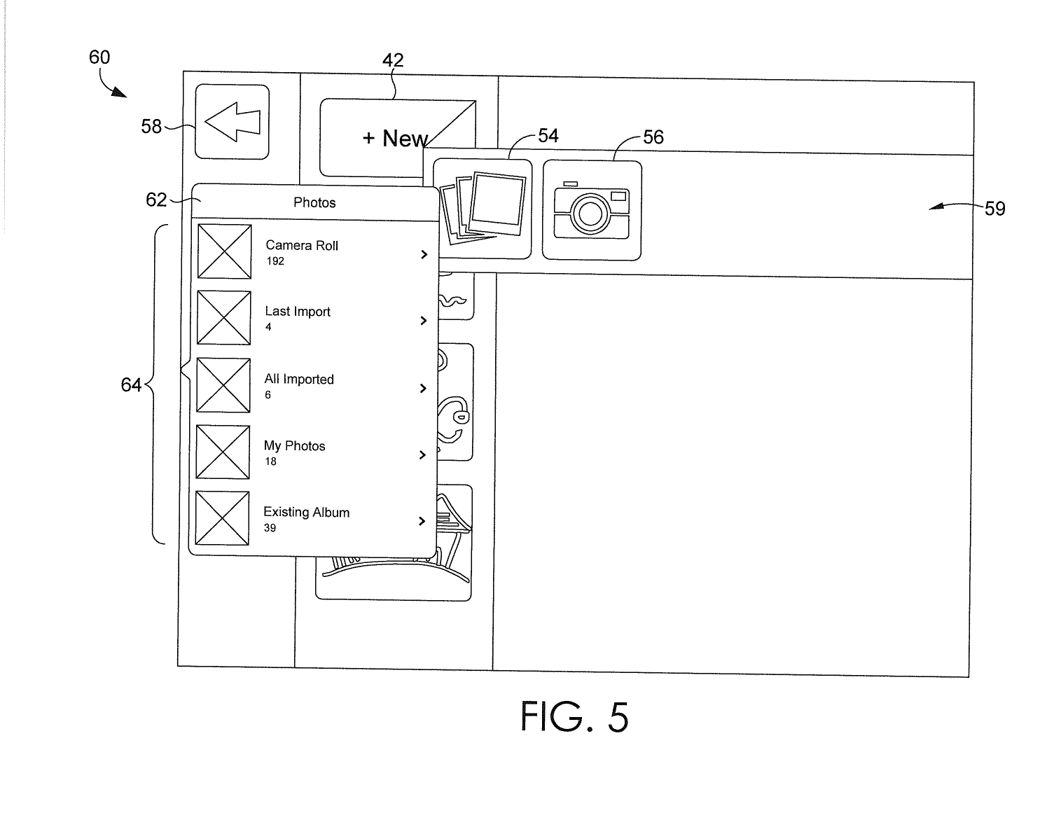

Upon user selection of the new drawing selection indicator 48, in some embodiments, a user interface 52 of FIG. 4 may be presented to a user. As shown in FIG. 4, the user interface 52 may include a series of source indicators, such as an existing image indicator 54 and a camera image indicator 56, and a return indicator 58. Additional indicators for generation of a new animation may be included in a banner 59 in further embodiments of the invention. In FIG. 5, user interface 60 depicts multiple options retrieved upon selection of the existing image indicator 54. In embodiments, a photo menu 62 may include one or more source options 64 for selection by a user.

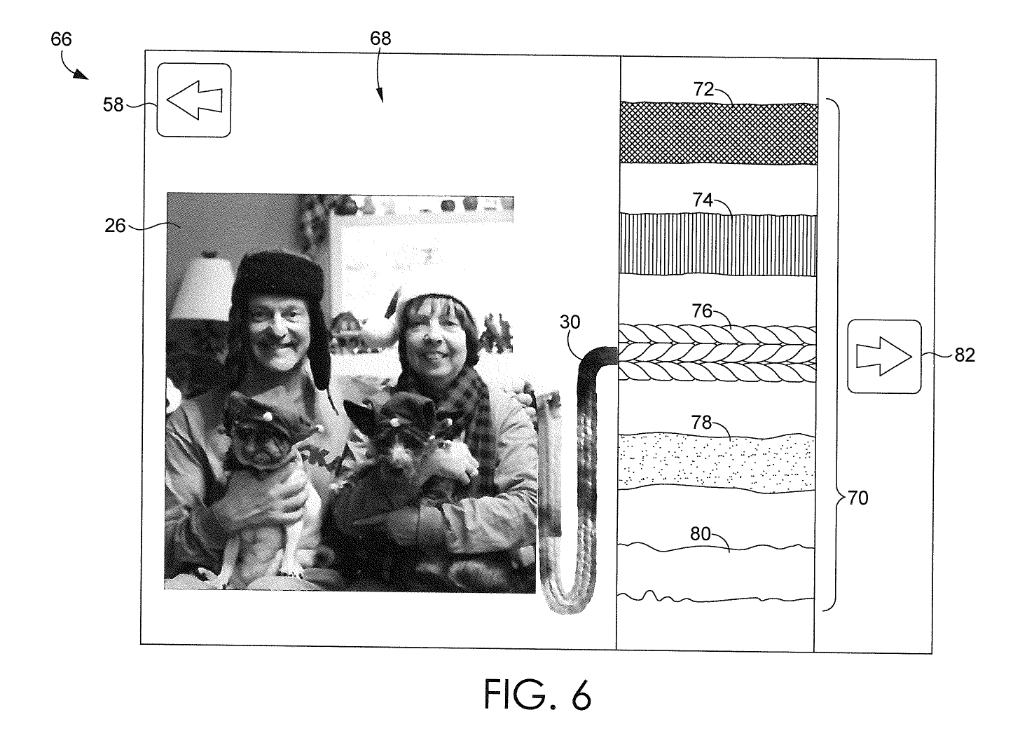

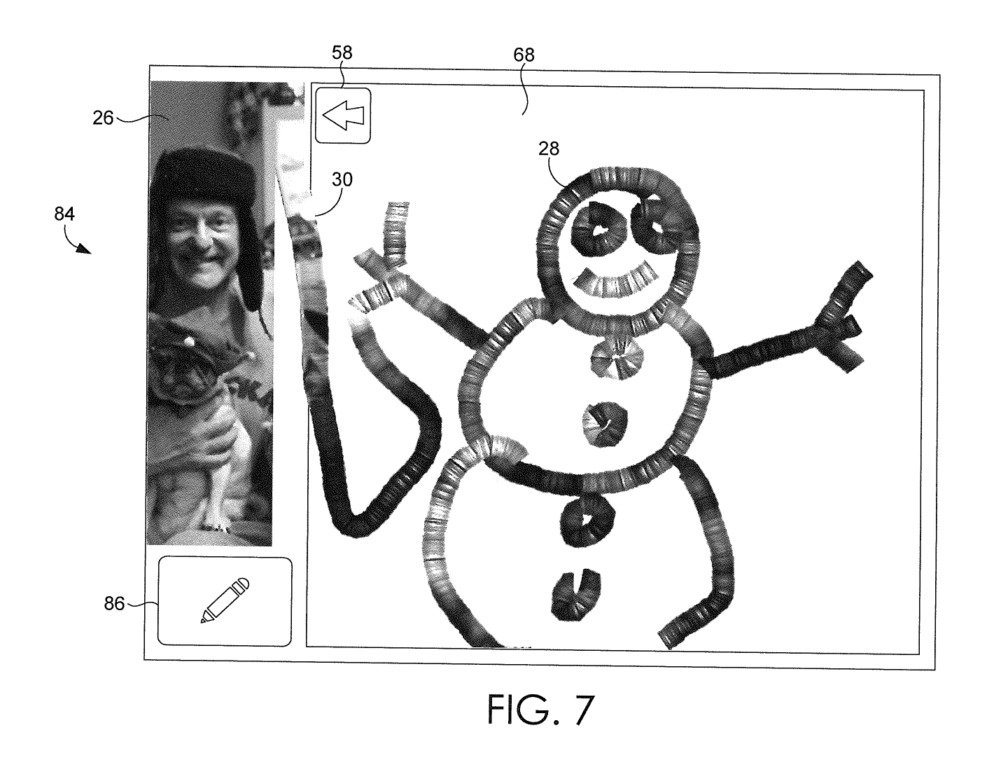

As seen in the exemplary embodiment of FIG. 6, a user interface 66 may include an image display 68 that includes the original image 26 selected by the user via source option 64. User interface 66 further includes a panel of string selection options 70, which may include a sweater fabric 72, embroidery 74, knitted stitches 76, glitter glue 78, melted crayon 80, and/or any number of additional options provided as part of string selection 70. Upon selection of drawing command 82, a selected string selection 70 item, as well as the original image 26, may then be used in the user interface 84 of FIG. 7. As shown in FIG. 7, the original image 26 may be shifted to a side of the user interface 84, such as the left side of the display, to provide a work space for drawing with the extracted thread 30. As such, a drawing selection indicator 86 may be used to initiate the creation of drawing 28 with thread 30, which is unwound from the original image 26. In some embodiments, a segment of the original image 26 is separated from the original image 26 along an edge of the original image. In one embodiment, the thread 30 is “pulled” from the original image 26, such as a photograph, and then used to draw with the selected texture of the string 30, such as a threadlike embroidery texture depicted in FIG. 7.

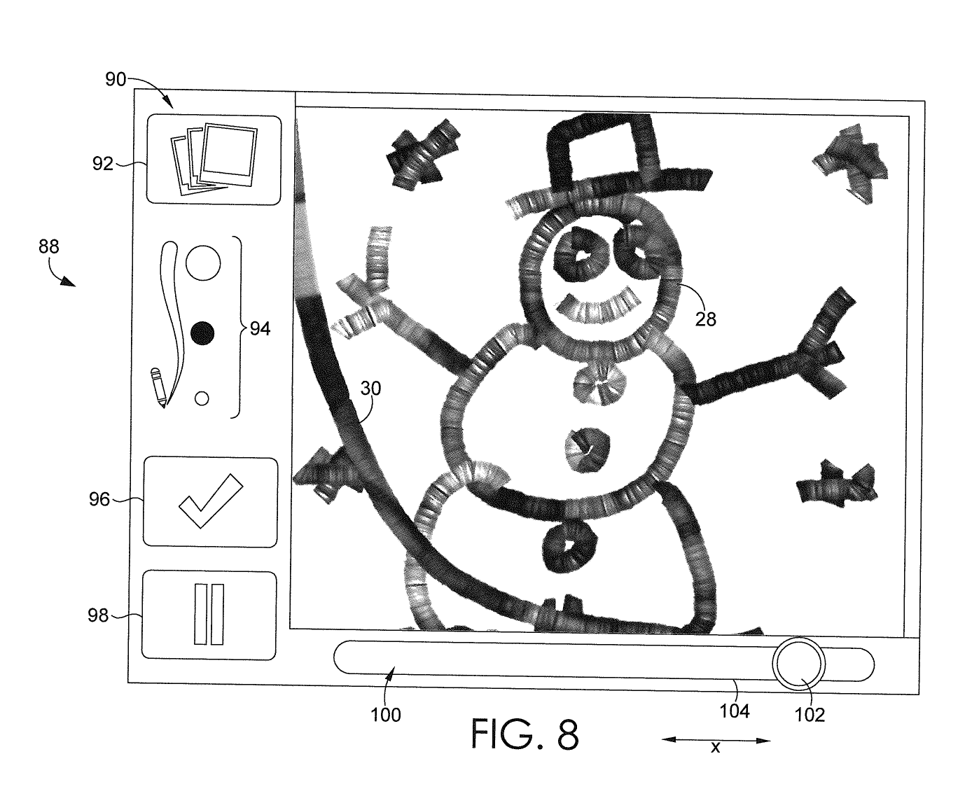

In FIG. 8, the user interface 88 depicts a menu 90 for further manipulation of the drawn image 28, having additional options 92, 94, 96, and 98, which provide corresponding manipulations such as selection of a photo source, string gauge, completion indicator, drawing pausing, and the like. Exemplary FIG. 8 also depicts a timeline tool 100 having a slider 102 that is manipulated back and forth along an x-axis of the track 104. In some embodiments, a user may manipulate the slider 102 to rewind or advance the drawn image 28 to different phases of drawing. As such, a user may return portions of the string 30 extracted from original image 26 to the original image 26, thereby “rewinding” the string 30 for future drawing. In embodiments, the creation of the user's drawn image 28 is recorded so that a user can return to any portion of the creation process using slider 102 along track 104. For example, a user may undo features of a drawn image 28 by rewinding to a particular phase of creation (i.e., point in time of the creation process) to then begin to re-create elements of the drawn image 28 using the rewound string 30.

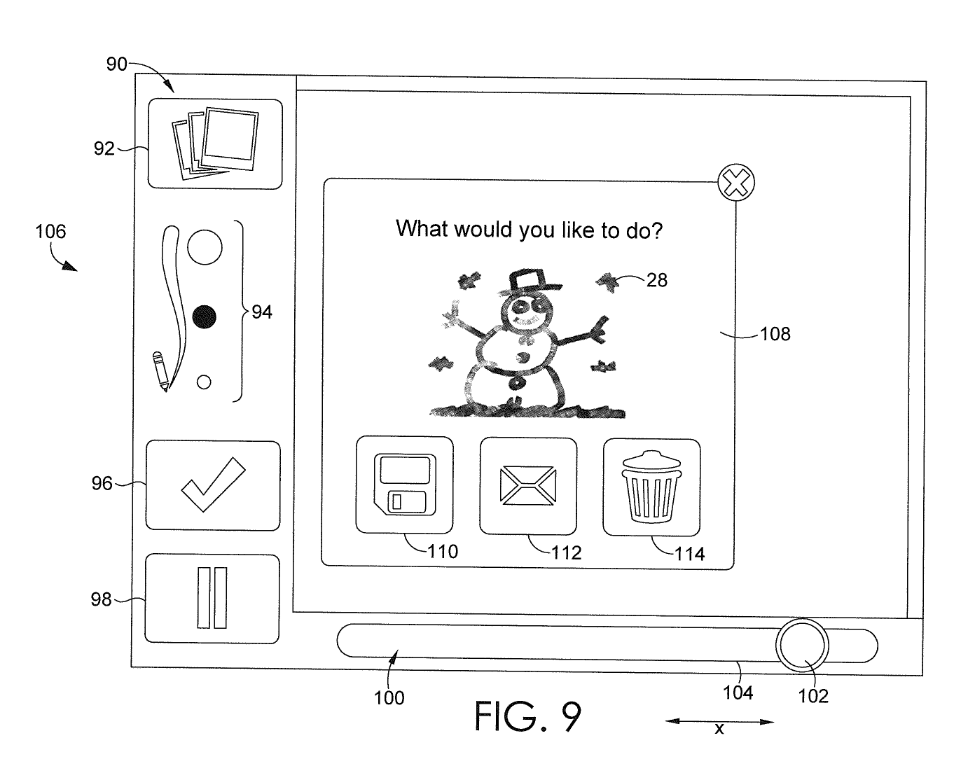

With reference finally to FIG. 9, the user interface 106 includes a prompt 108 that directs a user to indicate one or more actions to take with the created, drawn image 28. As such, in some embodiments, the prompt 108 includes a save option 110, an email option 112, and a delete option 114.

As such, a user may select an original image for creation, such as selection of a photo that is part of the user's personal images on a computing device. The user may then assign a particular string texture for use in drawing with the pixels of the selected, original photo. Upon generating a drawn image, based on unraveling the photo and drawing with the “string” derived from the original image (e.g., photo), the user may then select to email an animation of their creation to a recipient. As shown in FIG. 1A, the recipient may receive a photo as part of an email message. Upon animation, as shown in FIGS. 2A-2D, the photo may unravel to reveal a hidden message that is created using the colored pixels of the original (photo) image. In embodiments, the animation is a looping animation, such as a GIF, beginning with the original image, cycling through each phase of creation of the drawn image using the string extracted from the original image, and again returning the string to the original image by rewinding the extracting of the string.

In some embodiments, the string used to create the image (derived from the photo) is blurred and/or altered to have an appearance of a solid band of color representative of the portion of the photo from which it was extracted. In some embodiments, the image string includes a blurred representation of 10-15 pixels of the portion of the photo from which it was extracted. As such, for a photo including multiple colors, the corresponding string derived from that photo may include a blurred representation of that photo along a path of drawing. Having completed the animations of FIGS. 2A-2D, the completed drawn image of FIG. 1B may be presented to a user. In one embodiment, the completed drawn image is then “rewound” into the original image, such as progressing through the animation from FIGS. 2D, to 2C, to 2B, to 2A, to regenerate the original image of FIG. 1A.

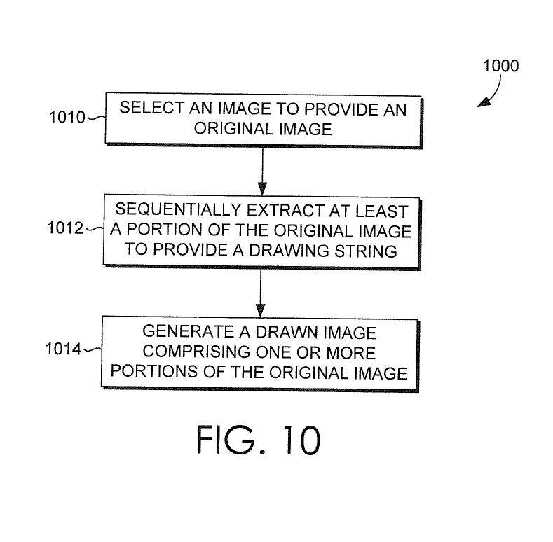

With reference to FIG. 10, a flow chart of a first exemplary method 1000 of generating a user-created artwork from an original image is provided, in accordance with an embodiment of the invention. At a first step 1010, an image is selected to provide an original image, such as the original image 10 shown in FIG. 1A. At a second step 1012, at least a portion of the original image is sequentially extracted to provide a drawing string, such as the drawing string 30 shown in FIG. 2A. At a third step 1014, a drawn image, such as the drawn image 28 shown in FIG. 2A, is generated comprising one or more portions of the original image. The drawn image may be configured for animation with respect to the original image, either by depicting an animation of unwinding the original image to the drawn image, or by depicting an animation of rewinding the drawn image to the original image, or both sequentially.

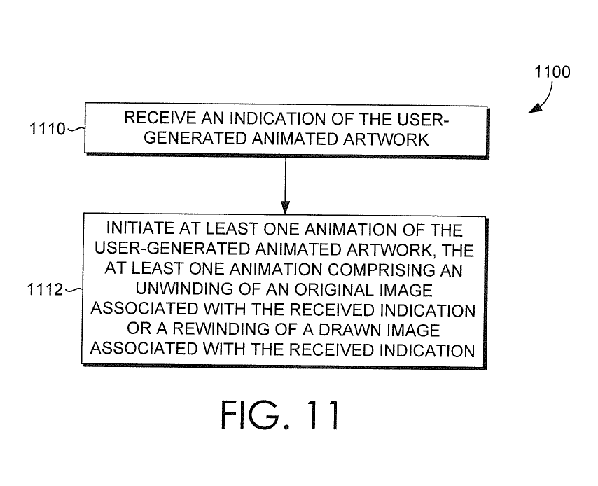

With reference to FIG. 11, a flow chart of a second method 1100 of generating a user-created artwork from an original image is shown, in accordance with an embodiment of the invention. At a first step 1110, an indication of user-generated animated artwork is received. At a second step 1112, at least one animation of the user-generated animated artwork is initiated, the at least one animation comprising an unwinding of an original image associated with the received indication, or a rewinding of a drawn image associated with the received indication.

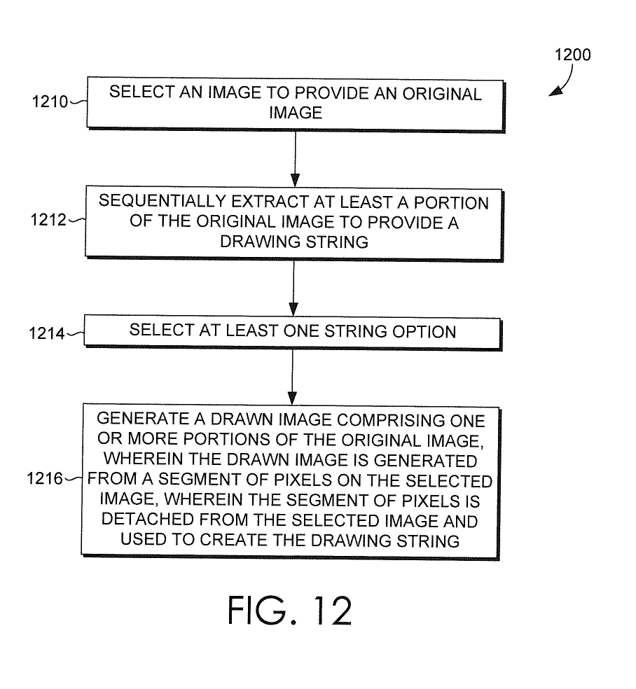

With reference to FIG. 12, a flow chart of a third method 1200 of generating a user-created artwork from an original image is shown, in accordance with an embodiment of the invention. At a first step 1210, an image is selected to provide an original image, such as the original image 10 shown in FIG. 1A. At a second step 1212, at least a portion of the original image is extracted to provide a drawing string, such as the drawing string 30 shown in FIG. 2A. At a third step 1214, at least one string option is selected. At a fourth step 1216, a drawn image, such as the drawn image 28 shown in FIG. 2A, is generated, the drawn image comprising one or more portions of the original image, wherein the drawn image is generated from a segment of pixels on the selected image, wherein the segment of pixels is detached from the selected image and used to create the drawing string.

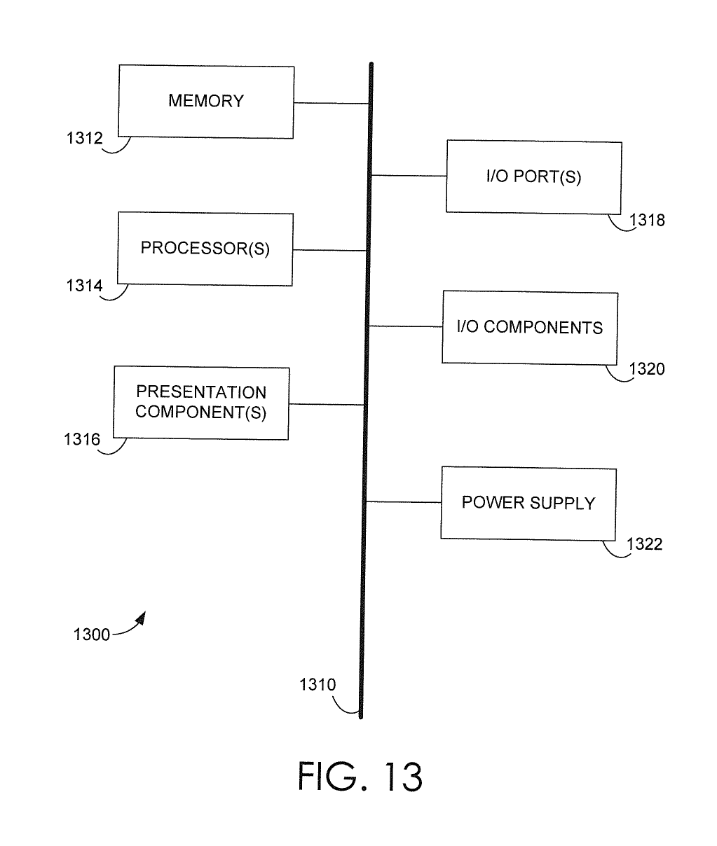

With reference to FIG. 13, an exemplary representation of a computing device configured to generate a user-created drawing and/or animation from an original image is shown, in accordance with an aspect of the invention. Computing environment 1300 is one example of a suitable computing environment, and is not intended to limit the scope of use or functionality of embodiments of the present invention. Neither should the computing environment 1300 be interpreted as having any dependency or requirement relating to any one and/or combination of components illustrated. In the exemplary embodiment of FIG. 13, the computing device 1300 includes a communication bus 1310, memory 1312, processor(s) 1314, presentation component(s) 1316, I/O port(s) 1318, I/O components 1320, and power supply 1322. As will be understood, one or more steps of image selection, retrieval, alternation, generation, animation, communication, delivery, conversion, extraction, recording, unwinding, rewinding, processing and/or translating may be processed by one or more features of and/or determined in association with processes executed by one or more computing devices, such as the exemplary computing device 1300.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated as within the scope of the claims.

1. A method, executed by a processor, for generating animated artwork from a photo string, the method comprising:
selecting an image to provide an original image;
sequentially extracting at least a portion of the original image to provide a drawing string; and
generating a drawn image comprising one or more portions of the original image.

2. The method of claim 1, wherein the original image is a photograph.

3. The method of claim 1, wherein the portion of the original image is a segment of pixels of the original image.

4. The method of claim 3, wherein the segment of pixels comprises 5 to 25 pixels.

5. The method of claim 1, wherein the drawn image is animated with respect to the original image.

6. The method of claim 1, further comprising selecting a string material corresponding to the drawing string.

7. The method of claim 1, further comprising translating a timeline tool to unwind or rewind at least a portion of the drawn image.

8. A method, executed by a processor, for interacting with a user-generated animated artwork, the method comprising:
receiving an indication of a user-generated animated artwork, said user-generated artwork comprising a drawn image created using a drawing string comprising a strand of pixels sequentially extracted from at least a portion of an original image; and
initiating at least one animation of the user-generated animated artwork, the at least one animation comprising:
(1) an unwinding of at least a portion of the original image associated with the received indication into a least a portion of the drawn image; or
(2) a rewinding of at least a portion of the drawn image associated with the received indication into at least a portion of the original image.

9. The method of claim 8, wherein the original image is a photograph.

10. The method of claim 8, wherein the method further comprises receiving an indication of completion of the drawn image.

11. The method of claim 10, wherein the drawn image is configured for animation with respect to the original image.

12. The method of claim 8, further comprising:
receiving an indication of rewinding from a timeline tool; and
sequentially rewinding a drawing string from the drawn image to the original image, wherein the drawing string comprises sequentially extracted color segments from at least a portion of the original image.

13. The method of claim 8, further comprising:
receiving an indication of unwinding from a timeline tool; and
sequentially unwinding a drawing string from at least a portion of the original image to the drawn image according to a previously-drawn image using the drawing string sequentially extracted from at least a portion of the original image.

14. One or more computer storage media storing computer-usable instructions that, when used by one or more computing devices, cause the one or more computing devices to perform the method comprising:
receiving an indication of an image selection to provide an original image;
sequentially extracting at least a portion of the original image to provide a drawing string; and
generating a drawn image comprising one or more portions of the original image, wherein the drawn image is generated from a segment of pixels on the original image, wherein the segment of pixels is sequentially separated from at least a part of the original image and used to create the drawing string.

15. The method of claim 14, further comprising receiving a selection of at least one string option, wherein the at least one string option comprises at least one of:
(1) a string color;
(2) a string texture; and
(3) a string pattern.

16. The method of claim 14, wherein generating the drawn image comprises selecting a string of color from the original image and manipulating the string of color to generate the drawn image, wherein as the string of color is manipulated, the original image unravels until either the drawn image is complete or the entire original image has been unraveled.

17. The method of claim 14, further comprising receiving an indication of manipulation from a timeline tool, wherein the timeline tool is configured to be scrubbed forward and backward corresponding to generation of the drawn image.

18. The method of claim 14, wherein receiving an indication of image selection comprises at least one of:
cropping the original image;
choosing a background option; and
choosing an animation material.

19. The method of claim 14, further comprising providing a resulting animation that depicts a transformation between the original image and the drawn image.

20. The method of claim 14, wherein as the original image is converted into the drawing string, two or more pixels of the separated portion of the original image are blurred to create a solid band of color that corresponds to the portion of the original image from which it was derived.
